(19) United States
(12) Patent Application Publication
(10) Pub. No.: US 2009/0310892 A1
(43) Pub. Date: Dec. 17, 2009

(54) Linear motion guide apparatus having changeable sealing structure

(75) Inventors: Jen-Sheng Chen, Taichung (TW); Min Yao Hsieh, Taichung (TW)

Correspondence Address: CHARLES E. BAXLEY, ESQUIRE, 90 JOHN STREET, SUITE 309, NEW YORK, NY, 10038, US

(73) Assignee: Hiwin Technologies Corp.

(21) Appl. No.: 12/214,188

(22) Filed: Jun. 17, 2008

(51) Int. Cl. F16C 29/02

(52) U.S. Cl. 384/15

(57) ABSTRACT

A linear motion guide device includes a slider slidably attached onto a guide rail, two end caps attached to two ends of the slider and each having a channel formed between two legs, two sealing members attached to the legs and located at two opposite side portions of the guide rail and each having a wiping member for engaging with the guide rail, and two further sealing members changeably attached to the legs and located farther away from the guide rail than the previous sealing members for making different sealing structures pr conditions with the guide rail, the end caps each include two anchoring slots formed in each leg for attaching the sealing members.

### BACKGROUND OF THE INVENTION

1. Field of the Invention

The present invention relates to a linear motion guide apparatus, and more particularly to a linear motion guide apparatus including one or more dust wipers or sealing members changeably attached to or disengaged from the linear motion guide apparatus for forming different or changeable sealing structures and for changeably sealing the linear motion guide apparatus.

2. Description of the Prior Art

Typical linear motion guide devices comprise a slider or slide block slidably attached onto a guide rail, and normally, a ball bearing device disposed between the slider and the guide rail for facilitating the sliding movement between the slider and the guide rail and for allowing the slider and the guide rail to be smoothly moved relative to each other.

For example, U.S. Pat. No. 4,854,741 to Mottate et al. discloses one of the typical linear motion rolling guide units comprising a slider or slide block slidably attached onto a guide rail, and a number of holding plates attached or secured onto the slide block with fasteners and each having a soft rubber member for engaging with the guide rail and for making a tight seal between the slide block and the guide rail and for wiping off the dust or particles or the like that may be engaged into the space formed between the slide block and the guide rail.

However, the holding plates are solidly attached or secured onto the slide block with the fasteners and may not be easily and quickly changed to the other holding plates, or may not be easily and quickly changed to the other sealing structures or sealing conditions.

U.S. Pat. No. 5,209,575 to Ohtake, U.S. Pat. No. 5,360,271 to Agari, and U.S. Pat. No. 6,030,124 to Moseberg et al. disclose three further typical linear motion rolling guide units each also comprising a slider or slide block slidably attached onto a guide rail, and two seals or wiper devices attached onto the two sides of the slide block or the end caps and having a soft rubber lips or lip portions for engaging with the guide rail and for making a tight seal between the slide block and the guide rail and for wiping off the dust or particles or the like that may be engaged into the space formed between the slide block and the guide rail.

However, similarly, the dust proof wiper devices or seals are also solidly secured onto the end cap or the slide block and may not be easily and quickly changed to the other holding plates, or may not be easily and quickly changed to the other sealing structures or sealing conditions.

The present invention has arisen to mitigate and/or obviate the afore-described disadvantages of the conventional linear motion guide devices.

### SUMMARY OF THE INVENTION

The primary objective of the present invention is to provide a linear motion guide apparatus including one or more dust wipers or sealing members changeably attached to or disengaged from the linear motion guide apparatus for forming different or changeable sealing structures and for changeably sealing the linear motion guide apparatus.

The other objective of the present invention is to provide a linear motion guide apparatus including two pairs of dust wipers or sealing members changeably attached to or disengaged from the end caps for allowing the end caps and the sealing members to be easily and quickly manufactured in a mass production and to be easily and quickly assembled together in order to reduce or decrease the manufacturing cost for the linear motion guide apparatus.

In accordance with one aspect of the invention, there is provided a linear motion guide apparatus comprising a guide rail, a slider slidably attached onto the guide rail for moving along the guide rail, two end caps attached to two ends of the slider respectively, and each end cap including a channel formed between two legs, two first sealing members selectively attached to the legs and located at two opposite side portions of the guide rail, and each first sealing member including a wiping member for engaging with the guide rail, and two second sealing members selectively and changeably attached to the legs and located at two opposite side portions of the guide rail, and each second sealing member including a wiping member for engaging with the guide rail, and the first sealing members being located closer to the guide rail than the second sealing members, the first and the second sealing members may be selectively and changeably attached to the legs, or may be attached to the legs simultaneously for forming different or changeable sealing structures and for changeably sealing the guide rail.

The end caps each include a first anchoring slot formed in each of the legs and communicating with the channel of the end cap for attaching the first sealing members, and a second anchoring slot formed in each of the legs and communicating with the channel of the end cap for selectively attaching the other or the second sealing members.

The first sealing members each include at least one catch for detachably engaging with the first anchoring slots of the end caps, and the second sealing members each include at least one catch for detachably engaging with the second anchoring slots of the end caps and for detachably anchoring the first and the second sealing members to the end caps.

The end caps each include a first extension for forming the first anchoring slot of the end cap, and a second extension for forming the second anchoring slot of the end cap, and the first extension is preferably extended closer to the guide rail than the second extension.

The first extension is preferably located between the first and the second anchoring slots of the end caps for engaging with the first sealing members.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a linear motion guide apparatus in accordance with the present invention;

FIG. 2 is a partial bottom plan schematic view of the linear motion guide apparatus;

FIG. 3 is a cross sectional view of the linear motion guide apparatus taken along lines 3-3 of FIG. 1;

FIGS. 4, 5 are cross sectional views similar to FIG. 3, illustrating the operation or the other arrangements of the linear motion guide apparatus;

FIG. 6 is a partial exploded view illustrating two end caps and two pairs of the dust wipers or sealing members of the linear motion guide apparatus; and

FIG. 7 is another partial exploded view illustrating one pair of the dust wipers or sealing members of the linear motion guide apparatus.

### DETAILED DESCRIPTION OF THE PREFERRED EMBODIMENT

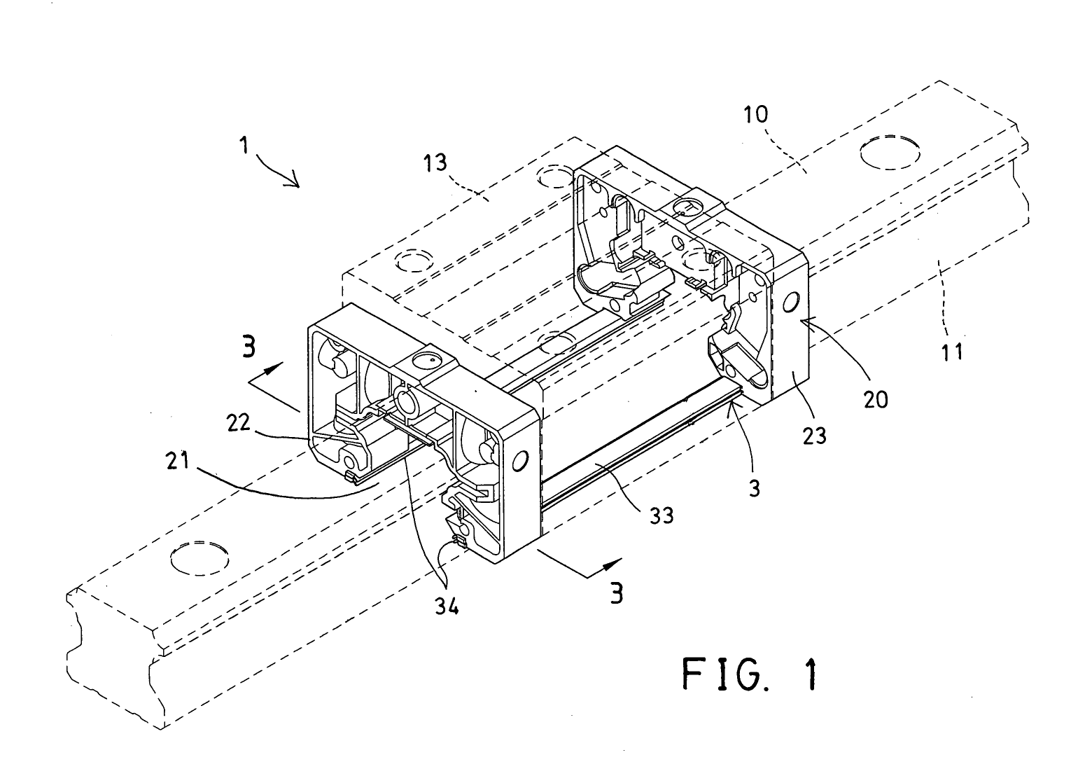

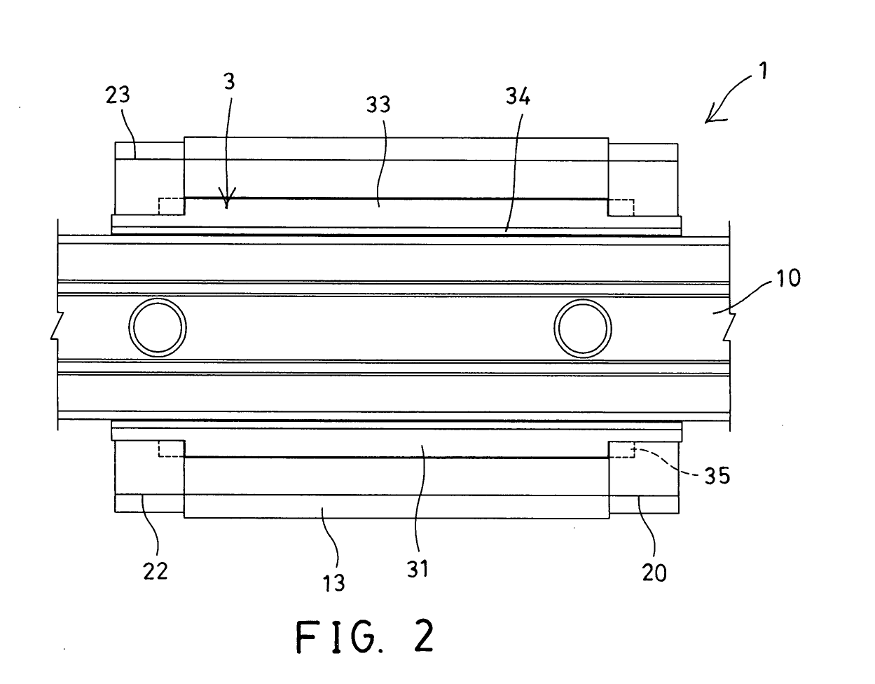

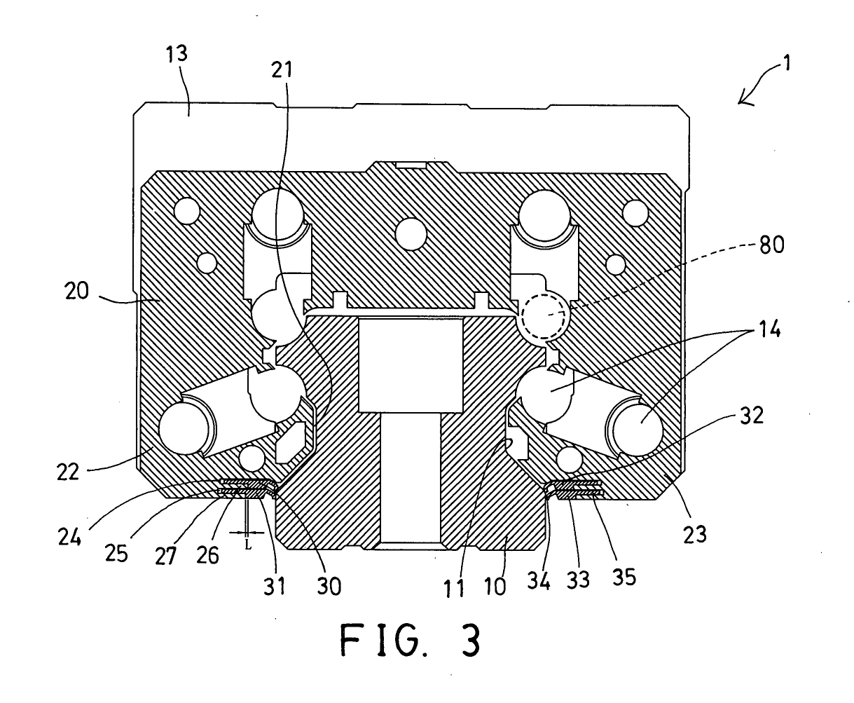

Referring to the drawings, and initially to FIGS. 1-3, a linear motion guide apparatus 1 in accordance with the present invention comprises a guide rail 10 including a substantially I-shaped cross section having two longitudinal recesses formed in the side portions 11 thereof, and a slide block or a slider 13 slidably attached onto the guide rail 10 and arranged to be moved along the guide rail 10, and normally, one or more ball guide raceway grooves 14 formed in the slider 13 or formed between the slider 13 and the guide rail 10 (FIGS. 3-5) for receiving a ball bearing device 80 (FIG. 3) and for facilitating the sliding movement between the slider 13 and the guide rail 10 and for allowing the slider 13 and the guide rail 10 to be smoothly moved relative to each other.

Two end caps 20 are disposed on the two ends or end portions or outer portions of the slider 13 and attached or secured to the slider 13 with such as fasteners or latches (not shown) or the like. The end caps 20 each include a channel 21 formed in the lower portion thereof (FIGS. 1 and 3-6) for slidably receiving or engaging onto the guide rail 10, and each include two legs 22, 23 for forming the channel 21 or having the channel 21 formed between the legs 22, 23 for stably engaging onto the guide rail 10. The above-described structure including the ball bearing device 80 and the slider 13 and the guide rail 10 is not related to the present invention and will not be described in further details.

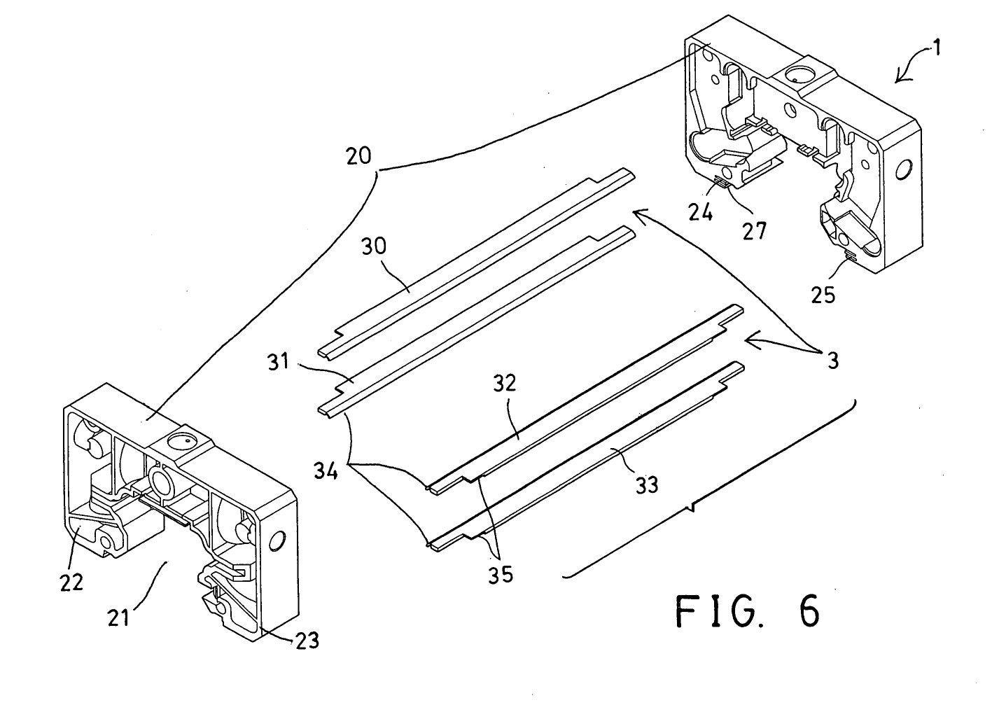

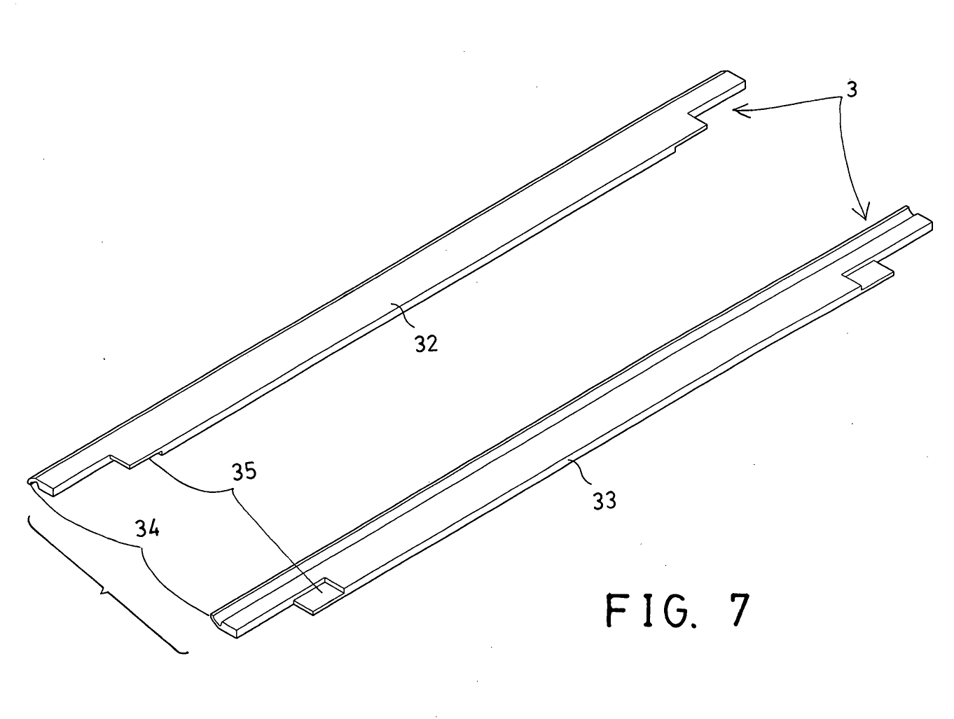

The linear motion guide apparatus 1 in accordance with the present invention further includes a wiper or sealing structure or device 3 having two pairs of dust wipers or sealing members 30, 3 1; 32, 33 (FIGS. 6, 7) for attaching or securing to the legs 22, 23 or the two sides portions of the end caps 20 and/or of the slider 13, and the two pairs of sealing members 30, 31; 32, 33 are located and engaged with the two opposite side portions 11 of the guide rail 10, and each include a soft or resilient or flexible wiping member 34 attached to or formed in the inner portion thereof for softly or resiliently engaging with the guide rail 10 and for wiping off or removing the dust or particles or the like that may be engaged into the space formed between the slide block 13 and the guide rail 10.

For example, the end caps 20 each include two or more anchoring slots 24, 25 formed in each of the legs 22, 23 and facing toward the channel 21 of the end cap 20 and/or communicating with the channel 21 of the end cap 20, and each include one or more extensions 26, 27 extended therefrom for forming the anchoring slots 24, 25 thereof and for engaging with the sealing members 30, 31; 32, 33 and for stably anchoring or positioning the sealing members 30, 31; 32, 33 to the end caps 20, and the extension 26 is preferably formed or located between the anchoring slots 24, 25 of the end caps 20. The sealing members 30, 31; 32, 33 each may include one or more ears or flaps or catches 35 formed or provided therein for engaging with the anchoring slots 24, 25 of the end caps 20 and for anchoring or positioning the sealing members 30, 31; 32, 33 to the end caps 20 respectively.

In operation, as shown in FIG. 3, the catches 35 of the sealing members 30, 31; 32, 33 may be engaged with the anchoring slots 24, 25 of the end caps 20 for anchoring or positioning or securing or attaching the sealing members 30, 3 1; 32, 33 to the end caps 20 respectively, and for allowing the soft or resilient or flexible wiping members 34 of the sealing members 30, 31; 32, 33 to be simultaneously engaged with the guide rail 10 and for forming a complete sealing structure to effectively wipe off or remove the dust or particles or the like that may be engaged into the space formed between the slide block 13 and the guide rail 10.

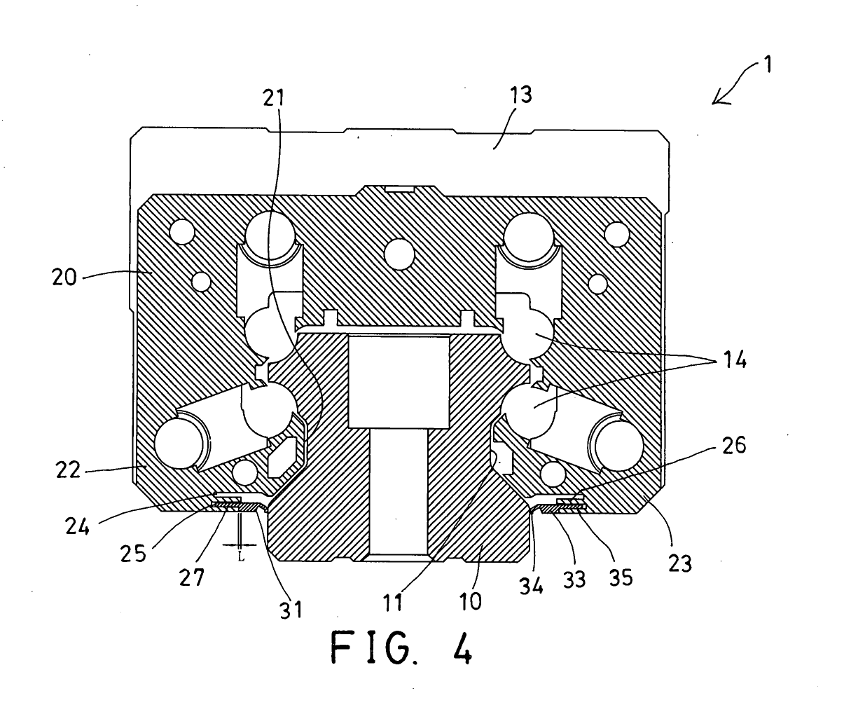

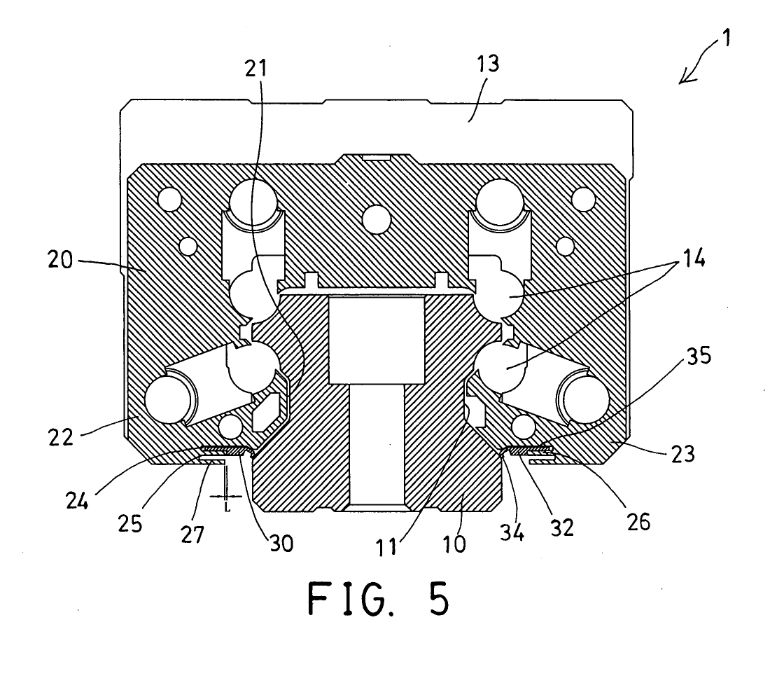

As shown in FIGS. 4 and 5, alternatively, the sealing members 30, 31; 32, 33 of each pair of the sealing members 30, 31; 32, 33 may be selectively changed or disengaged form the end caps 20 when the sealing requirement between the slide block 13 and the guide rail 10 is lowered or decreased or when it is not required to completely seal the space formed between the slide block 13 and the guide rail 10, such that the sealing structures or sealing conditions between the slide block 13 and the guide rail 10 may be selectively changed to different or changeable sealing structures for changeably sealing the linear motion guide apparatus 1.

It is to be noted that the extensions 26, 27 in each of the legs 22, 23 of the end caps 20 include different lengths, as best shown in FIGS. 3-5, for example, the extension 26 is longer than the other extension 27 for a length “L”, or the extension 26 is extended for a length “L” longer than that of the other extension 27, or the extension 26 is extended closer to the guide rail 10 for a length “L” than that of the other extension 27, and the sealing members 30, 32 which are engaged with the longer extensions 26 (FIG. 5) may be located or positioned closer to the guide rail 10 for making a better seal to the guide rail 10, and the other sealing members 31, 33 which are engaged with the shorter extensions 27 (FIG. 4) may be located or positioned slightly away from the guide rail 10 for making a decreased seal to the guide rail 10.

In operation, as shown in FIG. 4, the sealing members 31, 33 which are engaged with the shorter extensions 27 may make a decreased or less seal to the guide rail 10 than the other sealing members 30, 32 which are engaged with the longer extensions 26 and which may make an increased or better seal to the guide rail 10 (FIG. 5). As shown in FIG. 3, when the sealing members 30, 31; 32, 33 are simultaneously engaged with the guide rail 10, an excellent or complete sealing structure may be formed between the slide block 13 and the guide rail 10 in order to effectively wipe off or remove the dust or particles or the like that may be engaged into the space formed between the slide block 13 and the guide rail 10.

It is further to be noted that the sealing members 30, 31; 32, 33 may be easily and quickly assembled to the end caps 20 without additional tools, fasteners and the like, in addition, the end caps 20 and the sealing members 30, 31; 32, 33 may be easily and quickly manufactured in a mass production and may be easily and quickly assembled together such that the manufacturing cost for the linear motion guide apparatus 1 may be decreased.

Accordingly, the linear motion guide apparatus in accordance with the present invention includes one or more dust wipers or sealing members changeably attached to or disengaged from the linear motion guide apparatus for forming different or changeable sealing structures and for changeably sealing the linear motion guide apparatus.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A linear motion guide apparatus comprising:
a guide rail,
a slider slidably attached onto said guide rail for moving along said guide rail,
two end caps attached to two ends of said slider respectively, and each end cap including a channel formed between two legs, and
two first sealing members selectively attached to said legs and located at two opposite side portions of said guide rail, and each first sealing member including a wiping member for engaging with said guide rail.

2. The linear motion guide apparatus as claimed in claim 1, wherein said end caps each include a first anchoring slot formed in each of said legs and communicating with said channel of said end cap for attaching said first sealing members.

3. The linear motion guide apparatus as claimed in claim 2, wherein said first sealing members each include at least one catch for engaging with said first anchoring slots of said end caps.

4. The linear motion guide apparatus as claimed in claim 2, wherein said end caps each include a first extension for forming said first anchoring slot of said end cap.

5. The linear motion guide apparatus as claimed in claim 2 further comprising two second sealing members changeably attached to said first anchoring slots of said legs and located at two opposite side portions of said guide rail, and each second sealing member including a wiping member for engaging with said guide rail.

6. The linear motion guide apparatus as claimed in claim 5, wherein said second sealing members each include at least one catch for engaging with said first anchoring slots of said end caps.

7. The linear motion guide apparatus as claimed in claim 5, wherein said end caps each include a second anchoring slot formed in each of said legs and communicating with said channel of said end cap for attaching either of said first sealing members or said second sealing members.

8. The linear motion guide apparatus as claimed in claim 7, wherein said end caps each include an extension for forming said second anchoring slot of said end cap.

9. The linear motion guide apparatus as claimed in claim 7, wherein said end caps each include a first extension for forming said first anchoring slot of said end cap, and said first extension is located between said first and said second anchoring slots of said end caps.

10. The linear motion guide apparatus as claimed in claim 7, wherein said first sealing members are located closer to said guide rail than said second sealing members.
